(19) United States
(12) Patent Application Publication
(10) Pub. No.: US 2018/0215381 A1
(43) Pub. Date: Aug. 2, 2018

(54) AUTOMATIC SPEED CONTROL OF A VEHICLE TRAVERSING A WATER OBSTACLE

(71) Applicant: JAGUAR LAND ROVER LIMITED, Whitley, Coventry, Warwickshire, OT (GB)

(72) Inventors: Simon OWEN, Redditch, Worcestershire (GB); Karl RICHARDS, Leamington Spa, Warwickshire (GB)

(21) Appl. No.: 15/505,598

(22) PCT Filed: Jul. 22, 2015
(86) PCT No.: PCT/EP2015/066739

§ 371 Date: Feb. 21, 2017

(30) Foreign Application Priority Data
Aug. 21, 2014 (GB) 1414854.8

(51) Int. Cl. B60W 30/14; B60W 40/06; B60W 40/11; G01F 23/28; G01S 13/88

(52) U.S. Cl. CPC B60W 30/143; B60W 40/06; B60W 40/11; G01F 23/28; B60W 2550/14; B60W 2520/14; B60W 2520/16; B60W 2520/18; G01S 13/88

(57) ABSTRACT

A method of automatically controlling the speed of a vehicle as the vehicle traverses a water obstacle. The method includes the step of detecting that the vehicle has entered a water obstacle. The method further includes the step of determining a depth of the water proximate the vehicle based on readings or information received from, for example, one or more sensors or other components of the vehicle. And when the depth of the water exceeds a predetermined depth, the method still further includes the step of automatically reducing the speed of the vehicle such that a bow wave created in the water by the vehicle propagates ahead of the vehicle and in an intended direction of travel of the vehicle. A system for implementing the methodology is also provided.

### TECHNICAL FIELD

The present invention relates to vehicle speed control and particularly, but not exclusively, to automatically controlling the speed of a vehicle as the vehicle traverses a water obstacle. Aspects of the invention relate to a method, a non-transitory computer-readable storage medium, a system, a vehicle, and an electronic controller.

### BACKGROUND

As a vehicle enters and subsequently traverses a water obstacle, the depth of the water may be such that there is a risk of water entering an air intake of the vehicle engine which may result in damage to the engine. One way to lessen that risk is to cause a bow wave to be generated or created in the water that propagates ahead of the vehicle and in the vehicle's intended direction of travel and that serves to artificially reduce the water level ahead or about the vehicle, and particularly, around the air intake of the engine. Once the bow wave is created, it may also be desirable to follow a fixed distance behind it so as to maintain the reduced water level. Further it is desirable to follow a distance behind a bow wave as, as the bow wave comprises a mass of water at an increased height, if the vehicle travels immediately at the bow wave then the effect will be to increase the water height in comparison to the front of the vehicle.

One way in which a bow wave may be generated and subsequently followed is by the driver manually adjusting one or more operating parameter(s) of, or relating to, the vehicle. These operating parameters may include, for example and without limitation, the speed and/or entry angle of the vehicle as it enters the water obstacle, the speed of the vehicle once it has entered and is traversing the water obstacle, among potentially others. Accurately adjusting some or all of these operating parameter(s) may prove difficult for drivers having insufficient experience wading or traversing water obstacles; and inaccurately adjusting the parameter(s) may result in, for example, the generation of an inadequate bow wave (e.g., a bow wave of an insufficient height), the vehicle following too close to the bow wave, and/or the vehicle following too far behind the bow wave, any of which may result in damage to the engine or other vehicle components due to the water level proximate a least certain areas or locations of the vehicle being too high (e.g., at the air intake of the engine).

Accordingly, it is an aim of the present invention to address, for example, the disadvantages identified above.

### SUMMARY OF THE INVENTION

According to one aspect of the invention, there is provided a method of automatically controlling the speed of a vehicle as the vehicle traverses a water obstacle. In an embodiment, the method comprises: detecting that the vehicle has entered a water obstacle; determining a depth of the water proximate the vehicle; and when the depth of the water exceeds a predetermined depth, automatically reducing the speed of the vehicle such that a bow wave created in the water by the vehicle propagates ahead of the vehicle and in an intended direction of travel of the vehicle.

According to another aspect of the invention, there is a provided a system for automatically controlling the speed of a vehicle as the vehicle traverses a water obstacle. In an embodiment, the system comprises: means for detecting that the vehicle has entered a water obstacle; means for determining a depth of the water proximate the vehicle; and means for automatically commanding a reduction in the speed of the vehicle when the depth of the water exceeds a predetermined depth such that a bow wave created in the water by the vehicle propagates ahead of the vehicle and in an intended direction of travel of the vehicle. In an embodiment, the system comprises an electronic processor and an electronic memory device electrically coupled to the electronic processor and having instructions stored therein, wherein the processor is configured to access the memory device and execute the instructions stored therein such that it is operable to: detect that the vehicle has entered the water obstacle; determine the depth of the water proximate the vehicle; and when the depth of the water exceeds the predetermined depth, automatically command the reduction in the speed of the vehicle.

According to a still further aspect of the invention, there is provided an electronic controller for a vehicle having a storage medium associated therewith storing instructions that when executed by the controller cause the automatic speed control of a vehicle in accordance with the method of: detecting that the vehicle has entered a water obstacle; determining a depth of the water proximate the vehicle; and when the depth of the water exceeds a predetermined depth, automatically reducing the speed of the vehicle such that a bow wave created in the water by the vehicle propagates ahead of the vehicle and in an intended direction of travel of the vehicle.

According to yet another aspect of the invention there is provided a vehicle comprising the system described herein.

According to a further aspect of the invention, there is provided a non-transitory, computer-readable storage medium storing instructions thereon that when executed by one or more electronic processors causes the one or more processors to carry out the method described herein.

Optional features of the various aspects of the invention are set out below in the dependent claims.

At least some embodiments or implementations of the present invention have the advantage that when the vehicle enters a water obstacle, a bow wave may be created or generated in the water by automatically and (in at least certain instances) temporarily reducing the speed of the vehicle. This results in the water level directly ahead of the vehicle and immediately behind the bow wave being artificially reduced. By subsequently and automatically increasing the vehicle speed, the bow wave may be controlled to a fixed point ahead of the vehicle such that the water level surrounding at least certain portions of the vehicle (i.e., that where the air intake of the engine is located) is artificially reduced as the vehicle progresses and the bow wave propagates ahead of the vehicle. As such, the risk of damage to the engine and/or other components of the vehicle as a result of, for example, water entering the air intake of the engine, is eliminated or at least reduced.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the following figures in which:

FIG. 1 is a schematic and block diagram of a vehicle;

FIG. 2 is another block diagram of the vehicle illustrated in FIG. 1;

FIG. 3 is a diagram of a steering wheel for use with a vehicle, such as the vehicle illustrated in FIGS. 1 and 2;

FIG. 4 is a schematic and block diagram illustrating the operation of an example of a speed control system of a vehicle, such as the vehicle illustrated in FIGS. 1 and 2; and

FIGS. 5A and 5B are flow diagrams depicting various steps of illustrative embodiments of a method of automatically controlling the speed of a vehicle as the vehicle traverses a water obstacle.

### DETAILED DESCRIPTION

The system and method described herein may be used to automatically control the speed of a vehicle as the vehicle traverses a water obstacle. In an embodiment, the present system and method detect that the vehicle has entered a water obstacle, receive readings or information from one or more sensors or subsystems of the vehicle to determine a depth of the water proximate at least certain portion(s) of the vehicle, and when the depth of the water exceeds a predetermined depth, automatically reduce the speed of the vehicle such that a bow wave created in the water by the vehicle propagates ahead of the vehicle and in an intended direction of travel of the vehicle.

References herein to a block such as a function block are to be understood to include reference to software code for performing the function or action specified in which an output is provided responsive to one or more inputs. The code may be in the form of a software routine or function called by a main computer program, or may be code forming part of a flow of code not being a separate routine or function. Reference to function blocks is made for ease of explanation of the manner of operation of a control system according to an embodiment of the present invention.

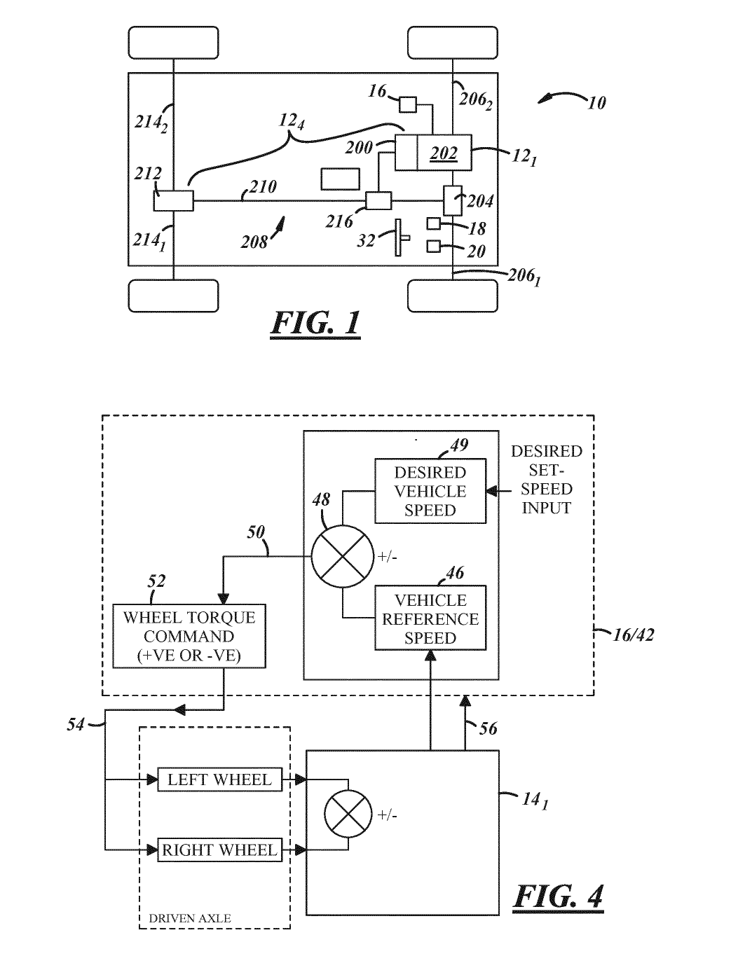

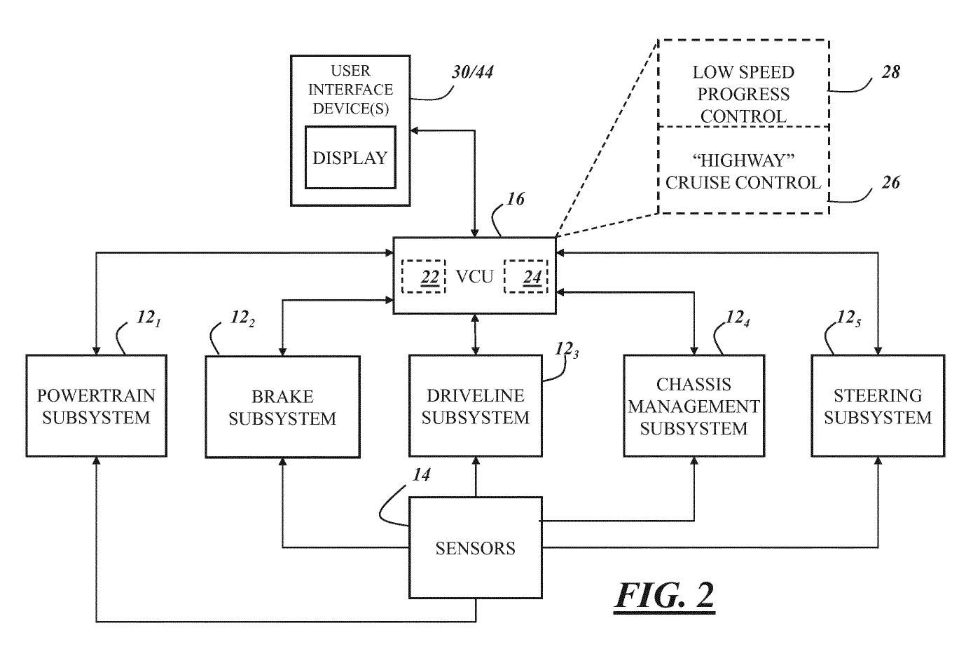

With reference to FIGS. 1 and 2, there are shown some of the components of a vehicle 10 with which the present system and method may be used. Although the following description is provided in the context of the particular vehicle illustrated in FIGS. 1 and 2, it will be appreciated that this vehicle is merely an example and that other vehicles may certainly be used instead. For instance, in various embodiments, the method and system described herein may be used with any type of vehicle having an automatic, manual, or continuously variable transmission, including traditional vehicles, hybrid electric vehicles (HEVs), extended-range electric vehicles (EREVs), battery electrical vehicles (BEVs), passenger cars, sports utility vehicles (SUVs), cross-over vehicles, and trucks, to cite a few possibilities. According to an embodiment, vehicle 10 generally includes a plurality of vehicle systems or subsystems 12, a plurality of vehicle sensors 14, and a vehicle control means in the form of an electronic controller 16 (which, in a non-limiting embodiment such as that described below, comprises a vehicle control unit (VCU) (i.e., VCU 16)), among any number of other components, systems, and/or devices that may or may not be illustrated or otherwise described herein.

Subsystems 12 of vehicle 10 may be configured to perform or control various functions and operations relating to the vehicle and, as illustrated in FIG. 2, may include any number of subsystems, for example and without limitation, a powertrain subsystem 12₁, a brake subsystem 12₂, a driveline subsystem 12₃, and a chassis management subsystem 12₄.

As is well known in the art, powertrain subsystem 12₁ is configured to generate power or torque (also referred to below as “drive torque”) that is used to propel the vehicle. The amount of torque generated by the powertrain subsystem may be adjusted so as to control the speed of the vehicle (e.g., to increase the speed of vehicle 10, the torque output is increased). The amount of torque that a powertrain subsystem is capable of outputting is dependent upon the particular type or design of the subsystem, as different powertrain subsystems have different maximum output torque capacities. In an embodiment, however, the maximum output capacity of powertrain subsystem 12₁ of vehicle 10 may be in the order of 600 Nm. As is known in the art, powertrain output torque may be measured using one or more of vehicle sensors 14 described below (e.g., an engine torque sensor, a driveline torque sensor, etc.) or other suitable sensing means, and may be used for a variety of purposes by one or more components, modules, or subsystems of vehicle 10 in addition to powertrain subsystem 12₁, including, for example and without limitation, one or more of those described below. Those having ordinary skill in the art will appreciate that powertrain subsystem 12₁ may be provided according to any number of different embodiments, may be connected in any number of different configurations, and may include any number of different components, such as, for example, output torque sensors, electronic control units, and/or any other suitable components known in the art. For instance, in an embodiment, powertrain subsystem 12₁ may include one or more electric machines, for example, one or more electric machines operable as electrical generators, that are configured to apply retarding torque and/or drive torque to a portion of the powertrain subsystem and/or one or more wheels of the vehicle so as to cause the vehicle to decelerate with or without the use of the brake subsystem (e.g., frictional braking) or to propel the vehicle, respectively. Accordingly, the present invention is not limited to any one particular powertrain subsystem.

Brake subsystem 12₂ is configured to generate brake torque (also referred to as “negative torque”) that is used to slow the vehicle. The application of a sufficient amount of brake torque to the wheel(s) of vehicle 10 results in the slowing down and/or stopping of the progress of vehicle 10. Brake subsystem 12₂ may take any number of forms known in the art, including, but certainly not limited to, one or a combination of electro-hydraulic, electro-mechanical, regenerative, and brake-by-wire systems.

In an embodiment, brake subsystem 12₂ is a hydraulic-based brake system. As will be appreciated by one having ordinary skill in the art, the brake subsystem 12₂ may include a brake pedal (pedal 18 shown in FIG. 1), an actuating rod, a master cylinder assembly, one or more brake or hydraulic lines, and one or more brake caliper assemblies (e.g., one for each wheel of vehicle 10), which, in turn, may include, for example, one or more caliper pistons, brake pads, and a brake disc (also called a rotor) that is coupled to an axle of vehicle 10. The operation of such a system is well known; however, for purposes of illustration, a brief summary will be provided. When pedal 18 is pressed to initiate a driver-demanded braking event, the actuating rod, which is coupled to pedal 18, applies a force onto a piston in the master cylinder that, in turn, causes fluid from a brake fluid reservoir to flow into the master cylinder. This results in an increase in fluid pressure in the brake system (i.e., also referred to as “brake pressure”) and results in brake or hydraulic fluid being forced through the hydraulic lines toward one or more of the caliper assemblies. When the fluid reaches a caliper assembly, the piston(s) thereof apply a force to the brake pad and pushes the pad against the brake disc. Friction between the pad and the brake disc results in the generation of a brake torque that is applied to the axle to which the brake disc is coupled, thereby causing the vehicle to decelerate. In any event, it will be appreciated that while a description of one particular example of a brake subsystem has been provided, the present invention is not intended to be limited to any one particular type of brake subsystem. For example, in an instance wherein the vehicle 10 is a hybrid or electrical vehicle the brake subsystem 12₂ may additionally or alternatively include one or more regenerative braking devices configured to apply negative or brake torque to one or more wheels (or corresponding axles) of the vehicle 10.

As will be described in greater detail below, in an embodiment, though certainly not the only embodiment, brake subsystem 12₂ may further include a controller or electronic control unit (ECU) that is configured and operable to perform, or to contribute to the performance of, various functions. For example, in an embodiment, brake subsystem 12₂ may include a dedicated brake controller (commonly referred to as an anti-lock brake system (ABS) controller) that is able to individually and separately control the brake torque applied to each wheel of vehicle 10, as well as to perform or control the performance of some or all of the steps of the methodology described below. Alternatively, some or all of this functionality may be performed by one or more other components of vehicle 10 in conjunction with brake subsystem 12₂.

As illustrated in FIG. 1, driveline subsystem 12₃ may include a multi-ratio transmission or gearbox 200 that is mechanically coupled with an output shaft of a propulsion mechanism of powertrain subsystem 12₁ (e.g., an engine or electric motor of powertrain subsystem 12₁, which is identified as reference number 202 in FIG. 1). Transmission 200 is arranged to drive the front wheels of vehicle 10 by means of a front differential 204 and a pair of front drive shafts 206₁, 206₂. In the illustrated embodiment, driveline subsystem 12₃ also comprises an auxiliary driveline portion 208 arranged to drive the rear wheels of vehicle 10 by means of an auxiliary driveshaft or prop-shaft 210, a rear differential 212, and a pair of rear drive shafts 214₁, 214₂. In various embodiments, driveline subsystem 12₃ may be arranged to drive only the front wheels or the rear wheels, or selectable two wheel drive/four wheel drive vehicles. In an embodiment such as that illustrated in FIG. 1, transmission 200 is releasably connectable to the auxiliary driveline portion 208 by means of a transfer case or power transfer unit 216, allowing selectable two wheel drive or four wheel drive operation. In certain instances, and as is well known in the art, transfer unit 216 may be configured to operate in either a high range (HI) or low range (LO) gear ratio, which may be adjustable by driveline subsystem 12₃ itself and/or by another component of vehicle 10, such as, for example, VCU 16. Those having ordinary skill in the art will appreciate that driveline subsystem 12₃ may be provided according to any number of different embodiments, implementations, or configurations, may be connected in any number of different configurations, and may include any number of different components, like sensors (e.g., HI/LO ratio sensor, transmission gear ratio sensors, etc.), control units, and/or any other suitable components known in the art. Accordingly, the present invention is not intended to be limited to any one particular driveline subsystem.

Chassis management subsystem 12₄ may be configured to perform, or may be configured to contribute to the performance of, a number of important functions, including, for example and without limitation, those relating to one or more of: traction control (TC); stability control systems (SCS) such as dynamic stability control (DSC); hill descent control (HDC); and steering control, to name only a few possibilities. To that end, and as is well known in the art, chassis management subsystem 12₄ may be further configured to monitor and/or control a variety of aspects or operational parameters of the vehicle using, for example, readings, signals, or information received from one or more of sensors 14 and/or other vehicle subsystems 12 described or identified herein. For example, subsystem 12₄ may be configured to monitor the attitude of the vehicle using readings or information received from one or more of sensors 14 and/or subsystems 12 described or identified herein (e.g., gyro sensors, vehicle acceleration sensors, etc.) to evaluate the pitch, roll, yaw, lateral acceleration, vibration (e.g., amplitude and frequency) of the vehicle (and/or the vehicle body, in particular), etc. Similarly, subsystem 12₄ may be configured to receive readings or other information relating to the ride height of the vehicle from, for example, one or more air suspension sensors that may be distributed about the vehicle. In such an instance, chassis management subsystem subsystem 12₄ may monitor the ride height of the vehicle and, if necessary and the vehicle is so configured, automatically make or cause to be made adjustments to the ride height using an air compressor (suspension compressor) onboard the vehicle. In certain implementations, chassis management subsystem 12₄ may additionally or alternatively be configured to receive readings or other information from one or more sensors 14 (e.g., water detection sensor(s), radar unit(s), etc.) or subsystems 12 of vehicle 10 and to use that or those readings or information to determine if vehicle 10 has entered or is currently traversing a water obstacle, and, in at least some embodiments, to determine the depth of the water obstacle proximate the vehicle.

In any event, the information received or determined by chassis management subsystem 12₄ may be utilized solely thereby or may alternatively be shared with other subsystems 12 or components of vehicle 10 (e.g., VCU 16, automatic speed control system(s), etc.) which may use the information for any number of purposes. While just certain examples of operational parameters or aspects of the vehicle that chassis management subsystem 12₄ may monitor and/or control have been provided, it will be appreciated that subsystem 12₄ may be configured to control and/or monitor any number of other or additional parameters/aspects of vehicle 10 in the same or similar manner as that described above. As such, the present invention is not intended to be limited to the control and/or monitoring of any particular parameter(s)/aspect(s). Moreover, it will be further appreciated that chassis management subsystem 12₄ may be provided according to any number of different embodiments, implementations, or configurations and may include any number of different components, for example, sensors, control units, and/or any other suitable components known in the art. Accordingly, the present invention is not intended to be limited to any particular chassis management subsystem(s).

In addition to those subsystems described above, vehicle 10 may further comprise any number of other or additional subsystems. For example, and as illustrated in FIG. 2, vehicle 10 may include a steering subsystem 12₅, to cite one possibility. For the purposes of this invention, each of these additional subsystems and the functionality corresponding thereto are conventional in the art. As such, detailed descriptions will not be provided; rather, the structure and function of those subsystems will be readily apparent to those having ordinary skill in the art.

In an embodiment, one or more of subsystems 12 may be under at least a certain degree of control by VCU 16 (a detailed description of which will be provided below). In such an embodiment, those subsystems 12 are electrically coupled to, and configured for communication with, VCU 16 to provide feedback to VCU 16 relating to operational or operating parameters of the vehicle, as well as to receive instructions or commands from VCU 16. Taking powertrain subsystem 12₁ as an example, powertrain subsystem 12₁ may be configured to gather various types of information relating to certain vehicle operating parameters, such as, for example, torque output, engine or motor speed, etc., and to communicate that information to VCU 16. This information may be gathered from, for example, one or more of vehicle sensors 14 described below. Powertrain subsystem 12₁ may also receive commands from VCU 16 to adjust certain operating parameters when, for example, a change in conditions dictates such a change (e.g., when a change in vehicle speed has been requested via a brake pedal (pedal 18 in FIG. 1) or an accelerator pedal (pedal 20 in FIG. 1) of vehicle 10). While the description above has been with particular reference to powertrain subsystem 12₁, it will be appreciated that the same principle applies to each such other subsystem 12 that is configured to exchange information/commands with VCU 16 or directly with one another.

In an embodiment, each subsystem 12 may include a dedicated control means in the form of one or more controllers (e.g., one or more electronic control units (ECUs)) configured to receive and execute instructions or commands provided by VCU 16, and/or to perform or control certain functionality (e.g., that of the methodology described below) independent from VCU 16. In such an embodiment, each controller may comprise any suitable ECU, and may include any variety of electronic processing devices, memory devices, input/output (I/O) devices, and/or other known components, and perform various control and/or communication related functions. In an embodiment, each controller may include an electronic memory device that may store various information, instructions, sensor readings (e.g., such as those generated by vehicle sensors 14), look-up tables, profiles, or other data structures (e.g., such as those used in the performance of the method described below), algorithms (e.g., the algorithms embodied in the method described below), etc. The memory device may comprise a carrier medium carrying a computer-readable code for controlling one or more components of vehicle 10 to carry out the method(s) described below. Each controller may also include one or more electronic processing devices (e.g., a microprocessor, a microcontroller, an application specific integrated circuit (ASIC), etc.) that executes instructions for software, firmware, programs, algorithms, scripts, applications, etc. that are stored in the corresponding memory device and may govern the methods described herein. Each controller may also be electronically connected to other vehicle devices, modules, subsystems, and components (e.g., sensors) via suitable vehicle communications and can interact with them when or as required.

Alternatively, two or more subsystems 12 may share a single control means in the form of one or more controllers, or one or more subsystems 12 may be directly controlled by the VCU 16 itself. In an embodiment wherein a subsystem 12 communicates with VCU 16 and/or other subsystems 12, such communication may be facilitated via any suitable wired or wireless connection, such as, for example, a controller area network (CAN) bus, a system management bus (SMBus), a proprietary communication link, or through some other arrangement known in the art. In any event, in an embodiment, the controller of each subsystem may include

For purposes of this disclosure, and notwithstanding the above, it is to be understood that the controller(s) or ECU(s) described herein may each comprise a control unit or computational device having one or more electronic processors. Vehicle 10 and/or a subsystem 12 thereof may comprise a single control unit or electronic controller or alternatively different functions of the controller(s) may be embodied in, or hosted in, different control units or controllers. As used herein, the term “control unit” will be understood to include both a single control unit or controller and a plurality of control units or controllers collectively operating to provide the required control functionality. A set of instructions could be provided which, when executed, cause said controller(s) or control unit(s) to implement the control techniques described herein (including the method(s) described below). The set of instructions may be embedded in one or more electronic processors, or alternatively, may be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

It will be appreciated that the foregoing represents only some of the possibilities with respect to the particular subsystems of vehicle 10 that may be included, as well as the arrangement of those subsystems with VCU 16. Accordingly, it will be further appreciated that embodiments of vehicle 10 including other or additional subsystems and subsystem/VCU arrangements remain within the spirit and scope of the present invention.

Vehicle sensors 14 may comprise any number of different sensors, components, devices, modules, systems, etc. In an embodiment, some or all of sensors 14 may provide subsystems 12 and/or VCU 16 with information or input that can be used by the present method, and as such, may be electrically coupled (e.g., via wire(s) or wirelessly) to, and configured for communication with, VCU 16, one or more subsystems 12, or some other suitable device of vehicle 10 (e.g., an automatic speed control system such as one or both of those described below). Sensors 14 may be configured to monitor, sense, detect, measure, or otherwise determine a variety of parameters or information relating to vehicle 10 and the operation and configuration thereof, and may include, for example and without limitation, any one or more of: wheel speed sensor(s); ambient temperature sensor(s); atmospheric pressure sensor(s); tyrc tire pressure sensor(s); gyro sensor(s) to detect yaw, roll, and pitch of the vehicle; vehicle speed sensor(s); longitudinal acceleration sensor(s); engine torque sensor(s); driveline torque sensor(s); throttle valve sensor(s); steering angle sensor(s); steering wheel speed sensor(s); gradient sensor(s); lateral acceleration sensor(s); brake pedal position sensor(s); brake pedal pressure sensor(s); brake pressure sensor(s); accelerator pedal position sensor(s); air suspension sensor(s) (i.e., ride height sensors); wheel position sensor(s); wheel articulation sensor(s); vehicle body vibration sensor(s); wading or water detection sensor(s) (for both proximity and depth of wading events); parking distance control sensor(s); transfer case HI-LO ratio sensor(s); air intake path sensor(s); vehicle occupancy sensor(s); longitudinal, lateral, and vertical motion sensor(s); camera(s), and radar unit(s), among others known in the art.

The sensors identified above, as well as any other sensors not specifically identified above but that may provide information that can be used by the present method, may be embodied in hardware, software, firmware, or some combination thereof. Sensors 14 may directly sense or measure the conditions for which they are provided, or they may indirectly evaluate such conditions based on information provided by other sensors, components, devices, modules, systems, etc. Further, these sensors may be directly coupled to, for example, VCU 16 and/or to one or more of vehicle subsystems 12, indirectly coupled thereto via other electronic devices, vehicle communications bus, network, etc., or coupled in accordance with some other arrangement known in the art. Some or all of these sensors may be integrated within one or more of the vehicle subsystems 12 identified above, may be standalone components, or may be provided in accordance with some other arrangement. Finally, it is possible for any of the various sensor readings used in the present method to be provided by some other component, module, device, subsystem, etc. of vehicle 10 instead of being directly provided by an actual sensor element. For example, VCU 16 or a subsystem 12 may receive certain information from the ECU of a (another) subsystem 12 rather than directly from a sensor 14. It should be appreciated that the foregoing scenarios represent only some of the possibilities, as vehicle 10 is not limited to any particular sensor(s) or sensor arrangement(s); rather any suitable embodiment may be used.

In an embodiment, VCU 16 may comprise any suitable ECU, and may include any variety of electronic processing devices, memory devices, input/output (I/O) devices, and/or other known components, and perform various control and/or communication related functions. In an embodiment, VCU 16 includes an electronic memory device 22 that may store various information, sensor readings (e.g., such as those generated by vehicle sensors 14), look-up tables or other data structures (e.g., such as those used in the performance of the method described below), algorithms (e.g., the algorithms embodied in the method described below), etc. Memory device 22 may comprise a carrier medium carrying a computer-readable code for controlling one or more components of vehicle 10 to carry out the method(s) described below. Memory device 22 may also store pertinent characteristics and background information pertaining to vehicle 10 and subsystems 12. VCU 16 may also include one or more electronic processing devices 24 (e.g., a microprocessor, a microcontroller, an application specific integrated circuit (ASIC), etc.) that executes instructions for software, firmware, programs, algorithms, scripts, applications, etc. that are stored in memory device 22 and may govern the methods described herein. As described above, VCU 16 may be electronically connected to other vehicle devices, modules, subsystems, and components (e.g., sensors) via suitable vehicle communications and can interact with them when or as required. In addition to the functionality that may be performed by VCU 16 described elsewhere herein, in an embodiment, VCU 16 may also be responsible for various functionality described above with respect to subsystems 12, especially when those subsystems are not also configured to do so. These are, of course, only some of the possible arrangements, functions, and capabilities of VCU 16, as other embodiments, implementations, or configurations could also be used. Depending on the particular embodiment, VCU 16 may be a stand-alone vehicle electronic module, may be incorporated or included within another vehicle electronic module (e.g., in one or more of the subsystems 12 identified above), or may be otherwise arranged and configured in a manner known in the art. Accordingly, VCU 16 is not limited to any one particular embodiment or arrangement.

In addition to the components and systems described above, in an embodiment, vehicle 10 may further comprise one or more automatic vehicle speed control systems. For example and with continued reference to FIG. 2, in an embodiment, vehicle 10 may further comprise a cruise control system 26, also referred to as an “on-highway” or “on-road” cruise control system, and a low-speed progress (LSP) control system 28, which may be referred to an “off-highway” or “off-road” progress control system.

On-highway cruise control system 26, which may comprise any number of conventional cruise control systems known in the art, is operable to automatically maintain vehicle speed at a desired “set-speed” set by the user. Such systems are generally limited in their use in that the vehicle must be traveling above a certain minimum threshold speed (e.g., 30 mph (approximately 50 kph)) for the system to be operable. As such, these systems are particularly suited for use in highway driving, or at least driving wherein there is not a lot of repeated starting and stopping, and that permits the vehicle to travel at a relatively high speed. As is known in the art, on-highway cruise control system 26 may include a dedicated or standalone ECU configured to execute and perform the functionality of the system, or alternatively, the functionality of cruise control system 26 may be integrated into another subsystem 12 of vehicle 10 (e.g., powertrain subsystem 12₁), or for example, VCU 16 (as is illustrated in FIG. 2).

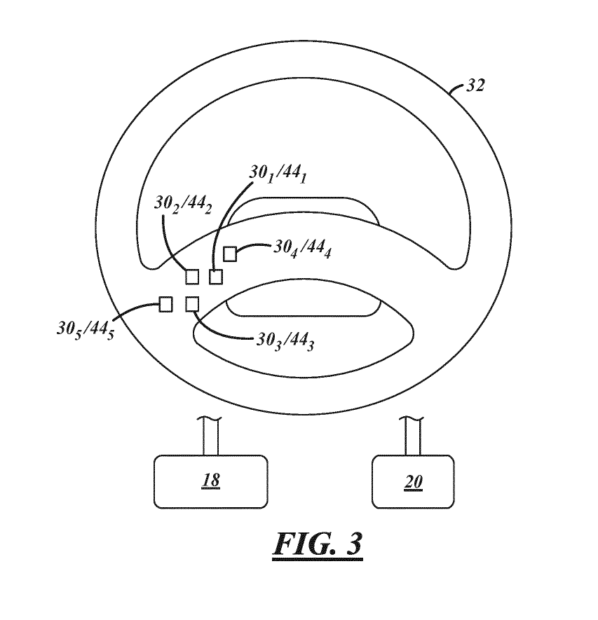

Further, and as is known in the art, cruise control system 26 may include one or more user interface devices 30 that may be used by the user (e.g., driver) to interact with system 26 (e.g., the ECU thereof), and in certain embodiments, that allow the system to interact with the user. For example, these devices may allow a user to activate/deactivate system 26 and set and/or adjust the set-speed of the system, to cite a few possibilities. Each of these devices may take any number of forms, such as, for example and without limitation, one or more of: a pushbutton; a switch; a touch screen; a visual display; a speaker; a heads-up display; a keypad; a keyboard; or any other suitable device. Additionally, these devices may be located at any number of locations within the vehicle cabin and in relatively close proximity to the user (e.g., steering wheel, steering column, dashboard, center console, etc.). For instance, and with reference FIG. 3, the steering wheel of vehicle 10 (i.e., steering wheel 32 in FIG. 1) may be configured with a plurality user interface devices of cruise control system 26 in the form of pushbuttons. One such device may be a “set speed” button 30₁ that when manipulated in a particular manner may activate the operation of cruise control system 26 and also set the desired set-speed. Cruise control system 26 may further comprise one or more other user-selectable interface devices (e.g., buttons) to allow the user to increase or decrease the set-speed of the system. For example, a “+” button 30₂ may be provided to allow the user to increase the set-speed in discrete increments (e.g., 1 mph (or 1 kph)), and a “−” button 30₃ to allow the user to decrease the set-speed in the same or different discrete increments. Alternatively, the “+” and “−” buttons 30₂, 30₃ may be integrated into a single user-selectable device. Additional user-selectable interface devices of system 26 may include, for example, a “cancel” button 30₄ to deactivate the system, as well as a “resume” button 30₅ to allow for the system to be re-activated following a temporary suspension of the system function, for example standard cruise control system go into a standby state where they do not control vehicle speed if the user brakes as detailed further below.

It should be appreciated that the foregoing scenarios represent only some of the possibilities of cruise control system 26 and the user interface devices thereof, as vehicle 10 is not limited to any particular cruise control system or user interface device or arrangement; rather, any suitable embodiments may be used.

LSP control system 28 provides a speed control system that enables, for example, the user of a vehicle equipped with such a system to select a very low target speed or set-speed at which the vehicle can progress without, for example, any pedal inputs being required by the user. This low-speed progress control function differs from that of cruise control system 26 in that unlike cruise control system 26, the vehicle need not be traveling at relatively high speeds (e.g., 30 mph (approximately 50 kph)) for the system to be operable (although system 28 may be configured to facilitate automated speed control at speeds from rest to around 30 mph (approximately 50 kph) or more, and therefore, is not limited to “low speed” operation). Furthermore, known on-highway cruise control systems are configured so that in the event the user presses or depresses the brake or the clutch pedals, for example, the on-road cruise control function is suspended and the vehicle reverts to a manual mode of operation requiring user pedal input to maintain vehicle speed and a dedicated operator input (e.g., a “resume” button) is needed to reactivate the cruise control in an active mode in which it controls vehicle speed. In addition, in at least certain cruise control systems, the detection of a wheel slip event, which may be initiated by a loss of traction, may also have the effect of cancelling the cruise control function. LSP control system 28 may also differ from such cruise control systems in that, in at least an embodiment, it is configured in such a way that the speed control function provided thereby may not be cancelled or deactivated in response to those events described above. In an embodiment, LSP control system 28 is particularly suited for use in off-road or off-highway driving.

In an embodiment, LSP control system 28 includes, among potentially other components, a control means in the form of a controller 42, which, in an embodiment such as that described below, comprises an ECU (i.e., ECU 42) (shown in the illustrated embodiment and for reasons described below as comprising VCU 16), and one or more user input devices 44. ECU 42 may include any variety of electronic processing devices, memory or storage devices, input/output (I/O) devices, and any other known components, and may perform any number of functions of LSP control system 28, including, in embodiment, some or all of those described below and embodied in the present method. To that end, ECU 42 may be configured to receive information from a variety of sources (e.g., vehicle sensors 14, vehicle subsystems 12, user input devices 44) and to evaluate, analyze, and/or process that information in an effort to control or monitor one or more operational aspects of vehicle 10, such as, for example: the speed of the vehicle; automatically commanding and controlling a drive torque generated by the powertrain subsystem 12₁ and/or a retarding torque generated and applied to one or more wheels of vehicle 10 by, for example, brake subsystem 12₂ (or driveline subsystem 12₃ or powertrain subsystem 12₁); determining the type and/or one or more characteristics of the terrain over which vehicle 10 is traveling (including, for example, the presence and/or depth of a water obstacle); etc. It should be appreciated that ECU 42 may be a standalone electronic module or may be integrated or incorporated into either another subsystem 12 of vehicle 10 or, for example, VCU 16. For purposes of illustration and clarity, the description below will be with respect to an embodiment wherein the functionality of ECU 42 is integrated or incorporated into VCU 16 such that, as illustrated in FIG. 2, VCU 16 comprises the ECU of LSP control system 28. Accordingly, in such an embodiment, VCU 16, and a memory device thereof or accessible thereby (e.g., memory device 22), in particular, stores various information, data (e.g., defined set-speeds), sensor readings, look-up tables or other data structures, algorithms, software, acceleration/deceleration profile(s), and the like, required for performing the functionality of LSP control system 28, including, in at least certain implementations, some or all of that embodied in the method described below.

As with on-highway cruise control system 26 described above, LSP control system 28 further comprises one or more user interface devices 44 that may be used by a user to interact with the system 28, and in certain embodiments, to allow the system 28 to interact with the user. These devices may allow the user to, for example, activate/deactivate LSP control system 28, set and/or adjust the set-speed of the system, select a desired set-speed from a plurality of predefined set-speeds, switch between two or more predefined set-speeds, identify the particular type of terrain vehicle 10 is traversing, and otherwise interact with system 28 as may be described below. These user interface devices may also allow for system 28 to provide certain notifications, alerts, messages, requests, etc. to the user including, but not limited to, those described herein below. Each of these devices may take any number of forms, such as, for example and without limitation, one or more of: a pushbutton; a switch; a touch screen; a visual display; a speaker; a heads-up display; a keypad; a keyboard; a selector knob or dial; or any other suitable device. Additionally, these devices may be located at any number of locations within the vehicle cabin and in relatively close proximity to the user (e.g., steering wheel, steering column, dashboard, etc.). In an embodiment, user interface devices 30, 44 of on-highway cruise control system 26 and LSP control system 28, respectively, are arranged adjacent to one another within vehicle 10, and, in an embodiment, on steering wheel 32 of vehicle 10. However, in other embodiments, such as, for example, that described herein, on-highway cruise control system 26 and LSP control system 28 may share some or all of the same user interface devices. In such an embodiment, an additional user-selectable device, such as a switch, pushbutton, or any other suitable device may be provided to switch between the two speed control systems. Accordingly, in the embodiment illustrated in FIG. 3, those user interface devices 30₁-30₅ described above with respect to cruise control system 26 may also be used in the operation of LSP control system 28, and as such, may also be referred to as user interface devices 44₁-44₅ when discussed in the context of system 28.

For purposes of illustration and in addition to the functionality of LSP control system 28 described below, a description of the general operation of one illustrative embodiment of LSP control system 28 will now be provided. First, VCU 16, which in the embodiment described herein comprises the ECU of LSP control system 28, determines the desired speed at which the vehicle is to travel (referred to herein as the “desired” or “target” set-speed). This may be a set-speed selected by the user via user interface devices 44 or, alternatively, VCU 16 may be configured to automatically determine or select a desired set-speed, or temporarily modify a user-selected set-speed, based on certain conditions or factors and without any user involvement. In either instance, in response to the selection of the desired set-speed, VCU 16 is configured to cause the vehicle to operate in accordance with the desired set-speed by effecting the application of selective powertrain, traction control, and/or braking actions to the wheels of the vehicle, collectively or individually, to either achieve or maintain the vehicle at the desired set-speed. In an embodiment, this may comprise VCU 16 generating and sending appropriate commands to the appropriate subsystems 12 (such as, for example, powertrain subsystem 12₁, brake subsystem 12₂, and/or driveline subsystem 12₃, depending the particular implementation), for example, and/or directly controlling the operation of one or more components, modules, subsystems, etc. of vehicle 10.

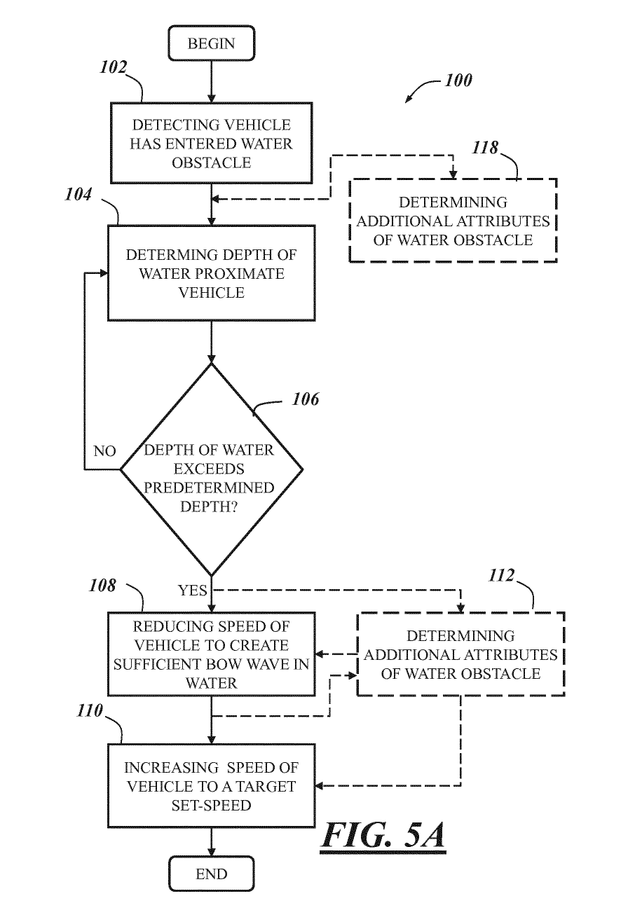

More particularly, and with reference to FIG. 4, once the desired set-speed is determined, a vehicle speed sensor (identified as sensor 14₁ in FIG. 4) associated with the vehicle chassis or driveline provides a signal 46 indicative of vehicle speed to VCU 16. In an embodiment, VCU 16 includes a comparator 48 which compares the desired set-speed (represented with reference numeral 49 in FIG. 4) with the measured speed 46, and provides an output signal 50 indicative of the comparison. The output signal 50 is provided to an evaluator unit 52, which interprets the output signal 50 as either a demand for additional torque to be applied to the vehicle wheels by, for example, powertrain subsystem 12₁, or for a reduction in torque to be applied to the vehicle wheels, by, for example, brake subsystem 12₂, depending on whether the vehicle speed needs to be increased or decreased to maintain or achieve the desired set-speed, and in the latter instance, to do so in accordance with a predetermined or prescribed acceleration profile, an acceleration corridor (e.g., +/−(0.1 g-0.2 g)), or both. An output 54 from the evaluator unit 52 is then provided to one or more subsystems 12 so as to manage the torque applied to the wheels, depending on whether there is a positive or negative demand for torque from the evaluator unit 52. In order to initiate the necessary positive or negative torque being applied to the wheels, the evaluator unit 52 may either command that additional power is applied to the vehicle wheels and/or that a braking force is applied to the vehicle wheels, either or both of which may be used to implement the change in torque that is necessary to achieve or maintain the desired vehicle set-speed. Synchronized application of positive (i.e., drive) and negative (i.e., retarding) torque to the wheels to control the net torque applied thereto and is commanded by LSP control system 28 to maintain vehicle stability and composure and regulate torque applied across each axle, in particular, in the event of a slip event occurring at one or more wheel. In certain instances, VCU 16 may also receive a signal 56 indicative of a wheel slip event having occurred. In such embodiments, during a wheel slip event, VCU 16 continues to compare the measured vehicle speed with the desired set-speed, and continues to control automatically the torque applied across the vehicle wheels so as to maintain vehicle speed at the desired set-speed and manage the slip event, for example by temporarily reducing the set-speed or reducing the drive torque so as to reduce wheel slip.

In addition to performing a speed control function, LSP control system 28 may be further configured to detect, sense, derive, or otherwise determine information relating to the terrain over which vehicle 10 is traveling (e.g., terrain type, surface type, terrain classification, terrain or surface roughness, water depth, etc.). In accordance with an embodiment, VCU 16 may be configured to perform this function and to do so in a number of ways. One such way for determining certain terrain-related information is that described in UK Published Application No. GB2492748A published on 16 Jan. 2013, the entire contents of which are incorporated herein by reference. More particularly, in an embodiment, information relating to a variety of different parameters associated with the vehicle are received or acquired from a plurality of vehicle sensors and/or various vehicle subsystems, including, for example, some or all of those sensors 14 and/or subsystems 12 described above. As is known in the art, the received information is then evaluated and used to determine one or more terrain indicators, which may represent the type of terrain and, in certain instances, one or more characteristics thereof, such as, for example, the classification, roughness, etc. of the terrain.

More specifically, in an embodiment, the speed control system (e.g., VCU 16) may include an evaluation means in the form of an estimator module to which the information acquired or received from one or more sensors 14 and/or subsystems 12 (collectively referred to as “sensor/subsystem outputs” below) is provided. Within a first stage of the estimator module, various ones of the sensor/subsystem outputs are used to derive a number of terrain indicators. In the first stage, vehicle speed is derived from wheel speed sensors, wheel acceleration is derived from wheel speed sensors, the longitudinal force on the wheels is derived from a vehicle longitudinal acceleration sensor, and the torque at which wheel slip occurs (if wheel slip occurs) is derived from a powertrain torque signal provided by the powertrain subsystem and additionally or alternatively from a torque signal provided by the driveline subsystem (e.g., transmission), and from motion sensors to detect yaw, pitch and roll. Other calculations performed within the first stage of the estimator module include the wheel inertia torque (the torque associated with accelerating or decelerating the rotating wheels), “continuity of progress” (the assessment of whether the vehicle is repeatedly starting and stopping, for example as may be the case when the vehicle is traveling over rocky terrain), aerodynamic drag, and lateral vehicle acceleration.

The estimator module also includes a second stage in which the following terrain indicators are calculated: surface rolling resistance (based on the wheel inertia torque, the longitudinal force on the vehicle, aerodynamic drag, and the longitudinal force on the wheels), the steering force on the steering wheel (based on the lateral acceleration and the output from a steering wheel sensor and/or steering column sensor), the wheel longitudinal slip (based on the longitudinal force on the wheels, the wheel acceleration, stability control system (SCS) activity and a signal indicative of whether wheel slip has occurred), lateral friction (calculated from the measured lateral acceleration and the yaw versus the predicted lateral acceleration and yaw), and corrugation detection (high frequency, low amplitude vertical wheel excitement indicative of a washboard type surface). The SCS activity signal is derived from several outputs from the ECU of a stability control system (SCS), which may contain a dynamic stability control (DSC) function, a terrain control (TC) function, anti-lock braking system (ABS), and hill descent control (HDC) algorithms, indicating DSC activity, TC activity, ABS activity, brake interventions on individual wheels, and powertrain torque reduction requests from the SCS ECU to the powertrain subsystem. All these indicate a slip event has occurred and the SCS ECU has taken action to control it. The estimator module also uses the outputs from wheel speed sensors and in a four wheel vehicle, compares outputs across each axle and from front to rear on each side, to determine a wheel speed variation and corrugation detection signal.

In an embodiment, and in addition to the estimator module, a road roughness module may also be included for calculating the terrain roughness based on air suspension sensors (the ride height or suspension articulation sensors) and wheel accelerometers. In such an embodiment, a terrain indicator signal in the form of a roughness output signal is output from the road roughness module.

In any event, the estimates for the wheel longitudinal slip and the lateral friction estimation are compared with one another within the estimator module as a plausibility check. Calculations for wheel speed variation and corrugation output, the surface rolling resistance estimation, the wheel longitudinal slip and the corrugation detection, together with the friction plausibility check, are then output from the estimator module and provide terrain indicator output signals, indicative of the nature of the terrain over which the vehicle is traveling, for further processing by VCU 16. For example, the terrain indicators may be used to determine which of a plurality of vehicle subsystem control modes (e.g., terrain modes) is most appropriate based on the indicators of the type of terrain over which the vehicle is traveling, and to then automatically control the appropriate subsystems 12 accordingly.

Additionally a system of the vehicle, for example the speed control system (e.g., VCU 16) is configured to determine the depth of a water obstacle proximate one or more areas or locations of the vehicle as the vehicle enters, traverses, and/or exits the water obstacle, and may do so in a number of ways. A detailed description of one illustrative way is set forth in International Patent Publication No. WO2013/120970A1 published on 22 Aug. 2013 (publication of PCT patent application no. PCT/EP2013/053022 filed 14 Feb. 2013), the entire contents of which are incorporated herein by reference. To summarize, however, wading sensors (e.g., ultrasound-based wading sensors) are used to measure the distance (d_{Sensed}) between the location of the wading sensors and the surface of the water. The measured distance is then subtracted from the known height of the wading sensors (h_{Sensor}) relative to the ground to determine the depth of the water (d_{Measured}). In certain instances, the height of the suspension may also be figured into the depth calculation by adding or subtracting a suspension height as part of the depth calculation. In instances wherein the vehicle is traveling up or down a slope or incline, the attitude (e.g., pitch, roll, etc.) of the vehicle and/or the grade of the slope (θ) may also be taken into account to determine the depth of the water at the forward and/or rearward end(s) of the vehicle. For example, and as described in Publication No. WO2013/120970A1, in an instance wherein the vehicle is descending a slope, the grade of the slope 6 may be determined and used with the known distance from the forward end of the vehicle to the wade sensors (L_{SensorToFront}) to determine/calculate an increased depth at the forward end of the vehicle. More particularly, the tangent of θ may be multiplied by the distance L_{SensorToFront} (i.e., tan θ*L_{SensorToFront}). This increased depth may then be added to the measured water depth d_{Measured}. A similar calculation can be made when the vehicle is ascending a slope such that the depth of the water is greater at the rearward end of the vehicle than it is at the forward end.

In another embodiment, rather than LSP control system 28 performing the above-described terrain sensing/detecting functionality, another component, module, or subsystem of vehicle 10, such as, for example VCU 16 (in the case where it does not perform the functionality of LSP control system 28), one of subsystems 12, or another suitable component (e.g., a dedicated wading monitor) may be appropriately configured to do so, and such other embodiments remain within the spirit and scope of the present invention.

It should be appreciated that the foregoing description of the arrangement, functionality, and capability of LSP control system 28 has been provided for purposes of example and illustration only and is not meant to be limiting in nature. Accordingly, LSP control system 28 is not intended to be limited to any particular embodiments or arrangements.

Again, the preceding description of vehicle 10 and the illustrations in FIGS. 1 and 2 are only intended to illustrate one potential vehicle arrangement and to do so in a general way. Any number of other vehicle arrangements and architectures, including those that differ significantly from the one shown in FIGS. 1 and 2, may be used instead.

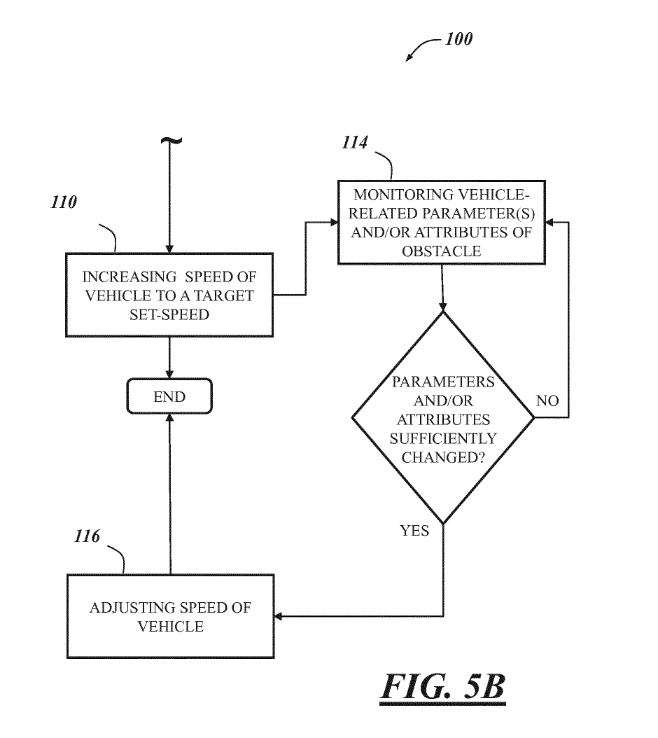

Turning now to FIGS. 5A and 5B, there are shown examples of a method 100 of automatically controlling the speed of a vehicle as the vehicle traverses a water obstacle. For purposes of illustration and clarity, method 100 will be described in the context of vehicle 10 described above and illustrated in FIGS. 1 and 2, and low-speed progress (LSP) control system 28 thereof, in particular, which for purposes of illustration is integrated in VCU 16 of vehicle 10 (i.e., VCU 16 comprises ECU 42 of LSP control system 28). It will be appreciated, however, that the application of the present methodology is not meant to be limited solely to such a vehicle or arrangement, but rather method 100 may find application with any number of arrangements (e.g., arrangements wherein the LSP control system is not integrated into the VCU of the vehicle, a component of the vehicle other than the LSP control system is configured to perform some or all of the steps of method 100, etc.). Additionally, it will be appreciated that unless otherwise noted, the performance of method 100 is not meant to be limited to any one particular order or sequence of steps or to any particular component(s) for performing the steps.

In an embodiment, method 100 comprises a step 102 of detecting that vehicle 10 has entered a water obstacle. This step may be performed in any number of ways known in the art including, but not limited to, those described below. One way is by receiving and using one or more readings or information in the form of one or more electrical signals(s) that is/are indicative of, or that may be used to detect, the vehicle having entered a water obstacle. The electrical signal(s) may be received from a number of sources, such as, for example and without limitation, one or more sensors 14 of the vehicle (e.g., water detection sensor(s)) or from another system or component of the vehicle 10 (e.g., a subsystem 12, for example, chassis management subsystem 12₄). Another way is by receiving and using one or more electrical signal(s) representative of a user input indicating that the vehicle has entered (or will be entering) the water obstacle. More particularly, a vehicle occupant may provide this input using a suitably configured user interface device, for example, one of user input devices 44 of LSP control system 28 described above and illustrated in FIG. 3, or another user interface device located within the vehicle cabin, for example, a knob, switch, pushbutton, touch screen display, or other suitable device. In each of the examples described above, the signal(s)/input(s) may be received directly from the source or indirectly therefrom via, for example, a CAN bus, a SMBus, a proprietary communication link or in another suitable manner.

It will be appreciated in view of the foregoing that any number of techniques may be used to detect or determine that the vehicle has entered a water obstacle, and therefore, the present invention is not intended to be limited to any particular technique(s) or way(s) for doing so.

When it is detected in step 102 that vehicle 10 has entered (or, in an embodiment, will be entering) a water obstacle, method 100 may move to a step 104 of determining (e.g., measuring or calculating) a depth of the water proximate at least certain areas or locations of the vehicle, for example, the depth at or near the forward or front end of the vehicle relative to the intended direction of travel (e.g., near the wing mirror(s)), the rear or rearward end of the vehicle relative to the intended direction of travel, and/or any other portion of the vehicle. In an embodiment, step 104 comprises receiving one or more readings or information in the form of electrical signal(s) from one or more vehicle sensors 14 and/or other components of vehicle 10 (e.g., subsystem(s) 12) that are either indicative of or that may be used to determine the depth of the water proximate the vehicle. As with the electrical signal(s) received in step 102, the electrical signal(s) or readings received and used in step 104 may be received directly from the pertinent subsystem and/or sensor(s) or indirectly therefrom via, for example, a CAN bus, SMBus, proprietary communication link, or in some other suitable manner. In any event, the received readings may be interpreted or processed and a depth (or depths) of the water proximate the vehicle may be determined. One way in which this may be carried out is that summarized above and described in detail in International Publication No. WO2013/120970A1, which was incorporated by reference above. It will be appreciated, however, that other suitable technique(s) or way(s) known in the art may also be used (e.g., radar technology, algorithms, equations, etc.), and therefore, the present invention is not limited to any particular way(s) or technique(s) of determining the depth of the water.

Once the depth of water proximate the vehicle has been determined in step 104, method 100 may proceed to a step 106 of determining whether the depth of water proximate the vehicle exceeds (or, in an embodiment, meets or exceeds) a predetermined depth. The predetermined depth may represent a depth at which, absent some preemptive action being taken (i.e., that described below), there is a possible risk of damage to the vehicle as a result of, for example, an undesirable amount of water entering the air intake of the engine. The predetermined depth may be an empirically-derived threshold programmed into an electronic memory device that is part of or accessible by the component configured to perform step 106, and may be specific to vehicle 10 taking into account vehicle characteristics, such as, for example, suspension height, the height of the air intake of engine relative to the ground, vehicle dimensions (e.g., wheelbase axle width, etc.), etc. In any event, in the illustrative embodiment depicted in FIG. 5A, step 106 comprises comparing the water depth determined in step 104 with the predetermined depth.

If it is determined in step 106 that the depth of the water proximate the vehicle does not exceed (or, in an embodiment, does not meet or exceed) the predetermined depth, method 100 may, as illustrated in FIG. 3, loop back to a previous step (e.g., step 104) or alternatively may simply end or terminate. If, on the other hand, it is determined in step 106 that the depth of the water does exceed (or, in an embodiment, meets or exceeds) the predetermined depth, method 100 may proceed to a step 108 of automatically effecting a reduction in the speed of the vehicle (i.e., actually reducing, or commanding a reduction in, the speed of the vehicle) such that a bow wave created in the water by the vehicle propagates ahead of the vehicle and in the intended direction of travel of the vehicle. In an embodiment, step 108 comprises a first determining an amount by which the vehicle speed should be reduced, and then effecting the reduction in the vehicle speed by that amount.

The amount by which the vehicle speed should be reduced may be dependent upon one or more factors, for example and without limitation, one or more of the speed of the vehicle as the vehicle enters the water obstacle, the depth of the water proximate the vehicle, vehicle dimensions (e.g., the height of the air intake), and/or the idle speed of the vehicle in the current gear. Another factor may be the amount by which the depth of the water determined in step 104 exceeds the threshold to which it was compared in step 106. More particularly, if the water is too deep (i.e., the depth determined in step 104 exceeds the threshold by more than a predefined amount), it may be desirable to bring the vehicle to, and hold the vehicle at, a complete stop or standstill rather than temporarily reducing the vehicle speed. In any event, in an embodiment, the relevant factor(s) may be used with a data structure that is programmed into a memory device that is part of or accessible by the component configured to perform step 108, for instance, an empirically-derived look up table or profile, and that correlates the relevant factor(s) with speed reduction magnitude. Alternatively, one or more algorithms, equations, and/or any other suitable technique may be utilized instead. Regardless of how it is determined, and depending on the particular implementation, the amount by which the vehicle speed should be reduced may be any amount up to and including the magnitude of the current speed of the vehicle. In other words, the vehicle speed may be reduced such that the vehicle slows but maintains progress, or such that the vehicle is brought to a stop or standstill.

The reduction in the vehicle speed may be effected a number of ways. One way is by reducing the amount of drive torque generated by the powertrain subsystem 12₁. This may comprise, for example, commanding the powertrain subsystem to reduce the amount of drive torque being generated and therefore applied to the wheel(s) of the vehicle. In such an embodiment, step 108 may comprise generating one or more commands (e.g., electrical signal(s)) and sending that or those commands to the powertrain subsystem to effect the reduction in the drive torque being generated thereby.

An additional or alternative way is by applying a certain amount of retarding or brake torque to one or more wheels of the vehicle. This may be accomplished in a number of ways. For example, brake subsystem 12₂ may be commanded (via one or more electrical signals) to apply a retarding torque to one or more wheels of the vehicle (e.g., the retarding torque may be applied via a brake disc of a wheel). If appropriately configured, powertrain subsystem 12₁ may also or alternatively be commanded to apply a retarding torque indirectly to one or more wheels. More particularly, in an embodiment wherein the powertrain subsystem includes one or more electric machines (e.g., one or more electric machines operable as electrical generators) configured to apply a retarding torque to a portion of the powertrain subsystem so as to cause the vehicle to decelerate with or without use of the brake subsystem, the powertrain subsystem may be commanded to apply the retarding torque in step 108. In other embodiments, components other than those described above may be utilized, for example and without limitation, a hill descent control (HDC) system of the vehicle, driveline subsystem 12₃ through a gear shift or change in gear ratio, etc. Accordingly, it will be appreciated that the present invention is not limited to any particular source of retarding torque; rather, any number of sources or combination of sources may be utilized. In any event, step 108 may comprise generating one or more commands (e.g., electrical signal(s)) and sending that or those commands to one or more components of the vehicle to effect the application of retarding torque directly or indirectly to the wheel(s) of the vehicle.

The particular amount of retarding torque that is commanded to be applied and, in certain implementations, the rate at which it is applied and the duration of the application (individually and collectively referred to below as “retarding torque-related parameter(s)”), and/or the amount by which the drive torque generated by the powertrain subsystem is reduced and, in certain implementations, the rate at which it is reduced and the duration of the reduction (individually and collectively referred to below as “drive torque-related parameter(s)”) may be dependent upon one or combination of factors. These factors may include vehicle-related factors and obstacle-related factors. Vehicle-related factors may include, for example and without limitation, the amount by which the speed is to be reduced, the amount or magnitude of the drive torque being generated by the powertrain subsystem 12₁ and therefore being applied to the wheels, the idle speed of the vehicle in the current gear, and/or vehicle dimensions (e.g., the height of the air intake), to cite a few possibilities. Obstacle-related factors may include water depth and possibly others relating to different attributes of the obstacle such as those described elsewhere below (e.g., obstacle width, whether there is a layer of ice on the surface of the water, etc.). The magnitudes of one or more of the aforementioned drive and/or retarding torque-related parameters may be determined in a number of ways. In an embodiment, one or more of the aforementioned factors may be used with a data structure programmed into a memory device that is part of or accessible by the component configured to perform step 108, for instance, an empirically-derived look up table or profile that correlates one or more of the factors with magnitude(s) of the relevant drive and/or retarding torque-related parameter(s). In another embodiment, a closed-loop control system (e.g., PID controller embodied in software in the component performing step 108) or any other suitable technique may be used.

In some implementations, instead of method 100 proceeding directly to step 108 following a determination in step 106 that the depth of the water exceeds a predetermined threshold, as described above, method 100 may include an intervening step (not shown) of comparing the depth of the water to a second, higher threshold that is representative of a depth that is considered to be too deep for the vehicle to traverse. If the depth determined in step 104 is below (or, in certain embodiments, meets or is below) the second threshold, method 100 may proceed to step 108 and the vehicle speed will be temporarily reduced in the manner described above. If, however, the depth exceeds (or, in certain embodiments, meets or exceeds) the second threshold, method 100 may proceed to step 108 and the vehicle may be brought to and held at a stop or standstill (i.e., the speed of the vehicle will not be subsequently increased as is done in step 110 described below). In some implementations, an alert may also be generated and displayed (using, for example, user interface(s) 44 of LSP control system 28) in the vehicle cabin indicating that the water may be too deep to traverse and optionally advising or instructing the driver to take corrective action (e.g., back up out of the obstacle).

Following the reduction in vehicle speed in step 108, method 100 may move to a step 110 of automatically increasing the speed of the vehicle to a predetermined target set-speed such that the vehicle follows behind the bow wave created in the water by the reduction in the vehicle speed in step 108. In an embodiment, step 110 comprises increasing the speed of the vehicle to the desired or target set-speed in accordance with which the vehicle speed was being controlled or maintained prior to entering the water obstacle. In another embodiment, step 110 may comprise determining a target set-speed that is appropriate for the prevailing conditions, and which may be the same as or different from the set-speed in accordance with which the vehicle speed was being controlled or maintained prior to entering the water obstacle. In such an embodiment, the set-speed may be determined based on one or more factors such as, for example, the depth of the water proximate the vehicle and/or other attributes or characteristics of the vehicle, the water obstacle (such as those described below), or both. One way this set-speed may be determined, though certainly not the only way, is by using the aforementioned factor(s) along with a data structure programmed into a memory device that is part of or accessible by the component configured to perform step 110, for example, an empirically-derived look up table or profile that correlates one or more of the factors with target set-speed. In another embodiment, a closed-loop control system (e.g., PID controller embodied in software in the component performing step 110) or any other suitable technique may be used. In any event, in at least some implementations, the target set-speed may be selected or determined such that as the vehicle progresses, it follows behind the bow wave at a distance considered to be optimal for the prevailing conditions.

Regardless of how the target set-speed is determined, one way the actual speed of the vehicle may be increased to the target set-speed is by reducing the amount of retarding torque applied directly or indirectly to the wheel(s) of the vehicle in step 108, if applicable. This may comprise, for example, commanding the source of the retarding torque applied in step 108 (e.g., the brake, powertrain, and/or driveline subsystems) to reduce the amount of retarding torque being applied to the wheel(s) of the vehicle. In such an embodiment, step 110 may comprise generating one or more commands (e.g., electrical signal(s)) and sending that or those commands to the appropriate vehicle component (subsystem) to effect the reduction in the applied retarding torque.

An additional or alternative way in which the vehicle speed may be increased is by generating a certain amount of drive torque to propel the vehicle in the intended direction of travel and at the desired set-speed. In such an embodiment, step 110 may comprise commanding, for example, the powertrain subsystem of the vehicle to generate a certain amount of drive torque that is sufficient to resume movement or progress of the vehicle in accordance with the desired set-speed. Accordingly, in an embodiment, step 110 may comprise generating one or more commands (e.g., electrical signal(s)) and sending that or those commands to, for example, the powertrain subsystem of the vehicle to effect the generation of a required amount of drive torque.

The particular amount of drive torque that the powertrain subsystem is commanded to generate and, in certain instances, the rate at which it is generated (i.e., drive torque-related parameter(s)), and/or the amount by which the retarding torque being applied to the wheel(s) of the vehicle is reduced and, in certain instances, the rate at which it is reduced (i.e., retarding torque-related parameter(s)), may be dependent upon one or combination of factors. These factors may include the one or more of the vehicle-related factors and/or obstacle-related factors described above with respect to step 108, as well as, for example, the amount by which the vehicle speed is to be increased and the amount of retarding torque being applied to the wheel(s) of the vehicle and that must be overcome or counteracted to accelerate the vehicle to the target set-speed, to cite a few possibilities. The amount(s) or magnitude(s) of the drive and/or retarding torque-related parameter(s) may be determined in a number of ways. In an embodiment, one or more of the aforementioned factors may be used with a data structure programmed into a memory device that is part of or accessible by the component configured to perform step 110, for instance, an empirically-derived look up table or profile that correlates one or more of the factors with magnitude(s) of the relevant drive and/or retarding torque related-parameter(s). In another embodiment, a closed-loop control system (e.g., PID controller embodied in software in the component performing step 110) or any other suitable technique may be used.

Once a sufficient amount of drive torque to propel the vehicle has been generated and/or the retarding torque has been sufficiently reduced such that the vehicle resumes movement or progress, step 110 may thereafter comprise automatically controlling the speed of the vehicle in accordance with the desired or target set-speed determined in step 110. This may be accomplished or achieved, for example, in the manner described above and illustrated in FIG. 4 with respect to LSP control system 28; though the present invention is not intended to be limited to any particular technique(s).

In some implementations, method 100 may further include one or more additional steps, some or all of which may be optional. For example, and with reference to FIG. 5A, in method 100 may further comprise a step 112 of determining one or more attributes of the water obstacle in addition to the depth of the water proximate the vehicle. One such attribute is the width of the water obstacle. Knowing the width of the obstacle may be beneficial as it may have an effect on the size and behavior of a bow wave created in response to the speed reduction in step 108. More specifically, if the obstacle is relatively wide, the volume of water ahead of the vehicle will disperse rapidly in directions other than the intended direction of travel, potentially resulting in the dissipation of the bow wave. As such, the amount by which the vehicle speed is increased in step 110 will need to be larger than if the obstacle were narrower so as to maintain the bow wave ahead of the vehicle as the vehicle progresses. Conversely, if the obstacle is relatively narrow, the bow wave does not dissipate as it would if the obstacle was wider; rather, the water is more concentrated which may result in an increase in the height of the bow wave and the reflection or ricocheting of water off the sides or banks of the obstacle and back towards the vehicle, possibly leading to undesirable consequences such as an undesirable amount of water entering the engine air intake. As such, the amount by which the vehicle speed is increased in step 110 may be smaller than if the obstacle were wider in order to, for example, avoid the reflected water. Another attribute of the obstacle that may be determined in step 112 is whether or not the obstacle has a thin layer of ice on its surface. Knowing whether there is ice on the surface of the obstacle may be beneficial as it may have an effect on the size of the bow wave that has to be created. More specifically, if there is a thin layer of ice on the surface, a larger bow wave than would ordinarily be necessary if there was no ice is needed in order to break the ice apart and propagate along the obstacle. As such, the amount and/or rate at which the vehicle speed is reduced in step 108 (and/or the amount and/or rate at which retarding torque is applied, drive torque reduced, or both) may be greater than if there was no ice on the surface of the obstacle.

In any event, in an embodiment wherein method 100 includes step 112, and step 112 includes determining the width of the obstacle and/or whether there is ice on its surface, these attributes may be determined using any number of known techniques. For example, readings or information (e.g., electrical signal(s)) indicative of or that may be used to determine the attributes may be received from one or more vehicle sensors 14 (e.g., parking distance sensor(s), radar unit(s), camera(s), etc.) or other components of vehicle 10. The reading(s) and/or information may then be interpreted or processed using techniques known in the art to determine the relevant attribute(s) of interest. As with the electrical signal(s) received in other steps describe above, the electrical signal(s) or readings received and used in step 112 may be received directly from the pertinent component(s) or indirectly therefrom via, for example, a CAN bus, SMBus, proprietary communication link, or in some other suitable manner. Once determined, the attribute(s) may be used for any number of purposes, including, for example and without limitation, in the determinations made in one or both of steps 108, 110. More particularly, the attribute(s) may be taken into account along with or instead of the factor(s) used to determine, for example, one or a combination of the amount by which to reduce the speed of the vehicle and/or the magnitude(s) or amount(s) of one or more retarding and/or drive torque-related parameters in step 108, and/or the speed to which the vehicle speed is increased in step 110 and/or the magnitude(s) or amount(s) of one or more retarding and/or drive torque-related parameters in step 110.

As shown in FIG. 5B, method 100 may also additionally or alternatively include a step 114 of continuously monitoring (e.g., in accordance with a predetermined sampling rate) one or more vehicle-related parameters and/or attributes of the water obstacle as the vehicle progresses or wades through the obstacle. For example, in an embodiment, step 114 may comprise monitoring the depth and/or width of the water obstacle. Each of these attributes of the obstacle may be monitored in a number of ways. In at least some implementations, values or magnitudes for one or both of the depth and width of the obstacle may be determined as described above with respect to step 106 and step 112, respectively. The values may then be processed or evaluated (e.g., compared to previously acquired values) to determine whether the depth and/or width of the obstacle has (sufficiently) increased, decreased, or remained relatively constant. It will be appreciated that while particular obstacle-related attributes have been specifically identified and described above, other attributes and/or parameters relating to the obstacle, the vehicle (e.g., vehicle speed, attitude (e.g., pitch), etc.), or both may additionally or alternatively be monitored. Accordingly, the present invention is not limited to monitoring of any particular attribute(s)/parameter(s) in step 114.

In an embodiment wherein method 100 includes step 114, method 100 may further include a step 116 of automatically adjusting (i.e., increasing or decreasing) the target set-speed and the speed of the vehicle based on changes to the attribute(s)/parameter(s) monitored in step 114. For example, as the width of the obstacle increases, the speed of the vehicle (and the set-speed) may be increased to allow the bow wave to be maintained ahead of the vehicle. Alternatively, the speed may be temporarily decreased as described above with respect to step 108 in order to re-create or re-generate the bow wave, and then subsequently increased as described above with respect to step 110 to follow the “new” bow wave. Conversely, if the width of the obstacle decreases, the vehicle speed (and the set-speed) may be decreased. Adjustments may also be made to the speed (and the set-speed) if the depth of the obstacle increases or decreases, respectively.

Accordingly, in an embodiment, step 114 may comprise first determining if an adjustment is required. One way this may be accomplished, though certainly not the only one, is by determining an appropriate set-speed for the current values or magnitudes of the monitored attribute(s)/parameter(s), and then comparing that set-speed to the desired or target set-speed at which the vehicle is currently being maintained. If the two speeds differ (or, in an embodiment, differ by at least a predetermined amount—e.g., 10%), then step 116 comprises adjusting the speed of the vehicle to the appropriate set-speed; otherwise, no change is made to the vehicle speed (or set-speed). The set-speed that is appropriate for the current values of the monitored attribute(s) may be determined in a number of ways, including, but not limited to, that described above with respect to step 110. More particularly, the monitored attribute(s) may be used along with a data structure programmed into a memory device that is part of or accessible by the component configured to perform step 116, for example, an empirically-derived look up table or profile that correlates the relevant attribute(s) with vehicle set-speed. In another embodiment, a closed-loop control system (e.g., PID controller embodied in software in the component performing step 116) or any other suitable technique may be used.

If it is determined that a speed adjustment is warranted, then step 116 may further include adjusting the speed (or commanding an adjustment to the speed) accordingly. In an instance wherein the target set-speed is decreased and thus the speed of the vehicle is to be decreased, such a modification or adjustment may be carried out in the same or similar manner as that described above with respect to step 108, or using another suitable technique. In an instance wherein the set-speed is to be increased and thus the speed of the vehicle is to be increased, such an adjustment may be carried out in the same or similar manner as that described above with respect to step 110, or in another suitable way. The relevant portions of the descriptions of steps 108 and 110 set forth above will not be repeated but rather are incorporate here by reference.

The functionality of steps 114, 116 may be beneficial as the vehicle progresses through the water obstacle to maintain, for example, a distance behind the bow wave as it propagates ahead of the vehicle in the vehicle's direction of travel that is considered to be optimal for the prevailing conditions. It may also be beneficial as the vehicle approaches the exit of, and then exits, the obstacle. More particularly, there may be instances where as the vehicle exits a water obstacle, the angle of exit (i.e., the grade of the slope or incline that the vehicle must traverse to exit the obstacle) can cause water to flow back at the vehicle in a direction substantially opposite the vehicle's direction of travel. In such an instance, it may be desirable to reduce the speed of the vehicle to reduce the speed at which the water hits the front of the vehicle. Accordingly, the pitch of the vehicle (or, if the vehicle is so configured, the grade of the terrain) may be monitored in step 114 and then the vehicle speed may be at least temporarily reduced in step 116, accordingly. In another embodiment, in an instance wherein the desired set-speed in accordance with which the vehicle speed is controlled or maintained as the vehicle traverses the obstacle (i.e., the speed determined in step 110) is other than the set-speed in accordance with which the vehicle speed was controlled or maintained before encountering the obstacle, the vehicle speed may be adjusted in step 116 to blend or ramp up or down to the previous set-speed. Accordingly, the speed of the vehicle may be adjusted in step 116 for any number of purposes.

In some embodiments or implementations, and as illustrated in FIG. 5, method 100 may optionally include an additional step 118 of assessing or evaluating one or more conditions or criteria to determine whether one or more steps of method 100 (e.g., step 104, 106, and/or 108) should even be performed. More particularly, when the vehicle is entering the water obstacle, it may be advantageous to wait until the leading wheels or axle of the vehicle have become sufficiently submerged and/or reached the low point in the obstacle before the speed is reduced in step 108 to generate or create the bow wave. One reason for this is that if step 108 is performed too early, the pressure exerted on the water by the vehicle will be insufficient to create a suitable bow wave; in other words, the vehicle will not be moving a large enough volume of water relative to the size of the vehicle to generate a suitable bow wave. Accordingly, in an embodiment, step 118 may include determining that the leading wheels of the vehicle have become sufficiently submerged and/or reached a low point of the obstacle (i.e., the wheels have reached the bottom of the slope or incline at the entrance to the obstacle), and may proceed to one or more subsequent steps only if it is determined that the vehicle has, in fact, reached that particular point. In an embodiment wherein such a determination is made, it may be made in a number of ways.

In some implementations, step 118 may include monitoring the pitch of the vehicle as the vehicle descends down a slope or gradient of the water obstacle, the grade of the slope, or both. The pitch of the vehicle and/or the grade of the slope may be monitored in a number of ways. For example, one or more electrical signals indicative of, or that may be used to derive, the pitch of the vehicle and/or the grade of the slop may be received directly or indirectly from an appropriately configured sensor 14 of vehicle 10 (e.g., a gyro sensor configured to measure or detect the pitch of the vehicle 10, a gradient sensor, etc.) or from another component of vehicle 10, for example, a subsystem 12 (e.g., chassis management subsystem 12₄, etc.). The signal(s), or the values represented thereby, may then be processed (e.g., compared to previously acquired values) to determine whether the pitch of vehicle and/or grade of the slope is increasing, decreasing, or remaining relatively constant. If it is determined that the pitch of the vehicle and/or the grade of the slope is increasing or remaining relatively constant, it can be further determined that the vehicle has not yet reached the bottom of the slope, and method 100 may not proceed to a subsequent step (e.g., step(s) 104, 106, and/or 108). If, however, it is determined that the pitch and/or grade is decreasing, the decrease or reduction may be treated as being indicative of the leading wheels or axle of the vehicle reaching the bottom of the slope. Method 100 may then proceed to a subsequent step, which, in the non-limiting example illustrated in FIG. 8, is step 104, but could alternatively be step 106 or 108.

While certain conditions or criteria have been identified and discussed above as conditions or criteria that may be used in step 118 to determine whether one or more steps of method 100 should be performed, it will be appreciated that other conditions/criteria may additionally or alternatively be evaluated and used for the same purpose. Accordingly, the present invention is not limited to the evaluation or use of any particular condition(s)/criteria.

The functionality of each of the steps of method 100 described above may be performed by any suitable means/component(s) of vehicle 10. For example, the functionality of at least some of the steps of method 100 may be performed by a suitably configured electronic processor, for example, an electronic processor of LSP control system 28 (which, in an embodiment, comprises VCU 16); while the functionality of other steps may be performed by a combination of components of vehicle 10, for example, an electronic processor (e.g., an electronic processor of LSP control system 28) and one or more subsystems 12 (e.g., powertrain subsystem 12₁, brake subsystem 12₂, etc.). It will be appreciated, however, that the present invention is not intended to be limited to any particular component(s) of vehicle 10 performing any particular functionality.

It will be appreciated in view of the above that at least some embodiments or implementations of the present invention have the advantage that when the vehicle enters a water obstacle, a bow wave may be created or generated in the water by automatically and, in at least certain instances, temporarily reducing the speed of the vehicle. This results in the water level directly ahead of the vehicle and immediately behind the bow wave being artificially reduced. By subsequently and automatically increasing and then further increasing or decreasing the vehicle speed as necessary, the bow wave may be controlled to a fixed or optimal point ahead of the vehicle such that the water level surrounding at least certain portions of the vehicle (i.e., the air intake of the engine) is artificially reduced as the vehicle progresses and the bow wave propagates ahead of the vehicle. As such, the risk of damage to the engine and/or other components of the vehicle as a result of, for example, water entering the air intake of the engine, is eliminated or at least reduced. Accordingly, the present invention may be considered to be a sort of wading cruise control wherein the driver need not manipulate either the accelerator or brake pedal as the vehicle traverses the water obstacle.

It will be understood that the embodiments described above are given by way of example only and are not intended to limit the invention, the scope of which is defined in the appended claims. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Further, the terms “electrically connected” or “electrically coupled” and the variations thereof are intended to encompass both wireless electrical connections and electrical connections made via one or more wires, cables, or conductors (wired connections). Other terms are to be construed using their broadest reasonable meaning unless they are used in a context that requires a different interpretation.

1. A method of automatically controlling the speed of a vehicle as the vehicle traverses a water obstacle, comprising:
detecting that the vehicle has entered a water obstacle;
determining a depth of the water proximate the vehicle;
determining whether the depth of the water proximate the vehicle exceeds a predetermined depth; and
when the depth of the water exceeds said predetermined depth, automatically reducing the speed of the vehicle such that a bow wave created in the water by the vehicle propagates ahead of the vehicle and travels in an intended direction of travel of the vehicle.

2. The method of claim 1, wherein reducing the speed of the vehicle comprises applying a retarding torque to one or more wheels of the vehicle, reducing the drive torque to one or more wheels of the vehicle, or both.

3. The method of claim 1, wherein reducing the speed of the vehicle comprises generating one or more commands to apply a retarding torque to one or more wheels of the vehicle, to reduce the drive torque to one or more wheels of the vehicle, or both.

4. The method of claim 2, wherein reducing the speed of the vehicle comprises determining an amount of retarding torque to be applied to one or more wheels of the vehicle, an amount by which to reduce the drive torque to one or more wheels of the vehicle, or both, and may further comprise determining a duration of the application of the retarding torque, a duration of the reduction in the drive torque, or both.

5. (canceled)

6. The method of claim 1, further comprising determining one or more additional attributes of the water obstacle, and wherein the nature of the reduction in vehicle speed is dependent upon at least one of the one or more additional attributes of the water obstacle, and wherein the one or more additional attributes of the water obstacle may comprise a width of the water obstacle, whether the water obstacle has ice on its surface, or both.

7. (canceled)

8. The method of claim 1, further comprising determining an amount by which to reduce the speed of the vehicle.

9. The method of claim 1, wherein after detecting that the vehicle has entered a water obstacle, the method further comprises:
evaluating one or more criteria to determine whether to automatically reduce the speed of the vehicle; and
when at least certain of the one or more criteria are met, receiving readings from one or more sensors of the vehicle to determine the depth of the water proximate the leading axle of the vehicle; and
automatically reducing the speed of the vehicle only when the depth of the water proximate the leading axle of the vehicle exceeds the predetermined depth, and wherein evaluating one or more criteria may comprise evaluating whether at least the leading axle of the vehicle has reached the bottom of a slope of the water obstacle that the vehicle is descending by:
monitoring, as the vehicle descends the slope, the pitch of the vehicle, the grade of the slope, or both; and
when a reduction in the pitch of the vehicle and/or the grade of the slope is detected, determining that at least the leading axle of the vehicle has reached the bottom of the slope.

10. (canceled)

11. The method of claim 1, wherein after reducing the speed of the vehicle, the method further comprises automatically increasing the speed of the vehicle to a predetermined speed such that the vehicle follows behind the bow wave created by the vehicle, and wherein the predetermined speed to which the vehicle speed is increased may be one of a user-defined or automatic speed control system-defined target set-speed of the automatic speed control system of the vehicle.

12. (canceled)

13. The method of claim 1, wherein after reducing the vehicle speed, the method further comprises:
monitoring one or more attributes of the water obstacle as the vehicle progresses through the obstacle; and
automatically adjusting the speed of the vehicle based on changes to one or more of the attribute(s) of the water obstacle.

14. A non-transitory, computer-readable storage medium storing instructions thereon that when executed by one or more electronic processors causes the one or more electronic processors to carry out the method of claim 1.

15. A system for automatically controlling the speed of a vehicle as the vehicle traverses a water obstacle, the system comprising:
means for detecting that the vehicle has entered a water obstacle;
means for determining a depth of the water proximate the vehicle;
means for determining whether the depth of the water proximate the vehicle exceeds a predetermined depth; and
means for automatically commanding a reduction in the speed of the vehicle when the depth of the water exceeds said predetermined depth such that a bow wave created in the water by the vehicle propagates ahead of the vehicle and travels in an intended direction of travel of the vehicle.

16. The system of claim 15, wherein the detecting means, receiving and determining means, and commanding means comprise:
an electronic processor; and
an electronic memory device electrically coupled to the electronic processor and having instructions stored therein,
wherein the processor is configured to access the memory device and execute the instructions stored therein such that it is operable to:
detect that the vehicle has entered the water obstacle;
determine the depth of the water proximate the vehicle;
determine whether the depth of the water proximate the vehicle exceeds a predetermined depth; and
when the depth of the water exceeds the predetermined depth, automatically command the reduction in the speed of the vehicle.

17. The system of claim 16, wherein the processor is operable to command the reduction in the speed of the vehicle by commanding the application of a retarding torque to one or more wheels of the vehicle, a reduction in drive torque to one or more wheels of the vehicle, or both.

18. The system of claim 17, wherein the processor is operable to determine an amount of retarding torque to be applied to one or more wheels of the vehicle, an amount by which to reduce the drive torque to one or more wheels of the vehicle, or both, and wherein the process or may instead or additionally be operable to determine a duration of the application of the retarding torque, a duration of the reduction in the drive torque, or both.

19. (canceled)

20. The system of claim 16, wherein the processor is operable to determine one or more additional attributes of the water obstacle, further wherein the nature of the reduction in vehicle speed is dependent upon at least one of the one or more additional attributes of the water obstacle and wherein the one or more additional attributes of the water obstacle comprises the width of the water obstacle, whether the water obstacle has ice on its surface, or both.

21. (canceled)

22. The system of claim 16, wherein after detecting that the vehicle has entered the water obstacle, the processor is operable to:
evaluate one or more criteria to determine whether to automatically reduce the speed of the vehicle; and
when at least certain of the one or more criteria are met, determine the depth of the water proximate the leading axle of the vehicle; and
automatically command a reduction in the speed of the vehicle only when the depth of the water proximate the leading axle of the vehicle exceeds the predetermined depth, and
wherein the processor may be operable to evaluate whether at least the leading axle of the vehicle has reached the bottom of a slope of the water obstacle that the vehicle is descending, and to do so by:
monitoring, as the vehicle descends the slope, the pitch of the vehicle, the grade of the slope, or both; and
when a reduction in the pitch of the vehicle and/or the grade of the slope is detected, determining that at least the leading axle of the vehicle has reached the bottom of the slope.

23. (canceled)

24. The system of claim 16, wherein after commanding a reduction in the vehicle speed, the processor is operable to automatically command an increase in the speed of the vehicle to a predetermined speed such that the vehicle follows behind the bow wave created by the vehicle.

25. The system of claim 15, wherein after commanding a reduction in the vehicle speed, the processor is operable to:
monitor one or more attributes of the water obstacle as the vehicle processes through the obstacle; and
command adjustments to the speed of the vehicle based on changes to one or more of the attribute(s) of the water obstacle.

26. A vehicle comprising the system according to claim 15.

27. An electronic controller for a vehicle having a storage medium associated therewith storing instructions that when executed by the controller causes the automatic control of the speed of the vehicle as the vehicle traverses a water obstacle in accordance with the method of:
detecting that the vehicle has entered a water obstacle;
determining a depth of the water proximate the vehicle;
determining whether the depth of the water proximate the vehicle exceeds a predetermined depth; and
when the depth of the water exceeds a predetermined depth, automatically reducing the speed of the vehicle such that a bow wave created in the water by the vehicle propagates ahead of the vehicle and travels in an intended direction of travel of the vehicle.
